(19) United States
(12) Patent Application Publication
(10) Pub. No.: US 2015/0361236 A1
(43) Pub. Date: Dec. 17, 2015

(54) BEAD POLYMER FOR PRODUCING PMI FOAMS

(71) Applicants: Thomas RICHTER, Darmstadt (DE); Sabine SCHWARZ-BARAC, Riedstadt (DE); Kay BERNHARD, Darmstadt (DE); Ina PIOTROWSKI, Griesheim (DE); Michael SCHNABEL, Biebesheim (DE); Sabrina SCHWEITZER, Biblis (DE); Dirk POPPE, Frankfurt am Main (DE); Johannes VORHOLZ, Alzenau (DE)

(72) Inventors: Thomas RICHTER, Darmstadt (DE); Sabine SCHWARZ-BARAC, Riedtadt (DE); Kay BERNHARD, Darmstadt (DE); Ina LIEBL, Griesheim (DE); Michael SCHNABEL, Biebesheim (DE); Sabrina SCHWEITZER, Biblis (DE); Dirk POPPE, Frankfurt am Main (DE); Johannes VORHOLZ, Alzenau (DE)

(73) Assignee: Evonik Roehm GmbH, Darmstadt (DE)

(21) Appl. No.: 14/765,472

(22) PCT Filed: Jan. 15, 2014
(86) PCT No.: PCT/EP14/50658

§ 371 Date: Aug. 3, 2015

(30) Foreign Application Priority Data
Feb. 15, 2013 (EP) 13155413.1

(51) Int. Cl. C08J 9/00

(52) U.S. Cl. CPC C08J 9/0023; C08J 2203/12; C08J 2333/08

(57) ABSTRACT

The invention relates to a foamable bead polymer consisting of (meth)acrylonitrile, (meth)acrylic acid, copolymerizable latent blowing agents and optionally (meth)acrylic esters, the preparation thereof by suspension polymerization and the use thereof for producing foams. Such a bead polymer makes it possible, for example, to carry out in-mould foaming in a simple way and thus produce products having the shape of the desired workpiece directly. These workpieces are highly suitable as components in space, air, water and land vehicles and for other construction elements.

### FIELD OF THE INVENTION

The invention relates to a foamable bead polymer consisting of (meth)acrylonitrile, (meth)acrylic acid, copolymerizable latent blowing agents and optionally (meth)acrylic esters, the preparation thereof by suspension polymerization and the use thereof for producing foams. Such a bead polymer makes it possible, for example, to carry out in-mould foaming in a simple way and thus produce products having the shape of the desired workpiece directly. These workpieces are highly suitable as components in space, air, water and land vehicles and for other construction elements.

### PRIOR ART

Poly(meth)acrylimide foams based on (meth)acrylic acid, (meth)acrylonitrile and optionally (meth)acrylic esters are known for their high compressive strength and heat resistance. These foams are normally produced in the form of cast boards by polymerization of the corresponding monomers in the presence of blowing agents and these boards are, after polymerization is complete, foamed by heat treatment to give foam boards. According to the prior art, these boards have to be cut up into shaped parts in a further process step. This procedure is naturally associated with a higher loss in yield.

To prevent this loss of material from cutting to size, WO 2012/013393 has provided a process for in-mould foaming. Here, the cast boards are milled to give granules before foaming. These granules are subsequently introduced into a mould and foamed there to give an accurate shape. However, this process also has the disadvantage that although granulation is a simpler process step compared to cutting to size, it is still an additional process step. Furthermore, the shaped part produced by this method has a lower mechanical strength than a shaped part cut from block. This is due to the interfaces between the foam regions formed from individual granules.

To improve adhesion at the interfaces, the international patent application number PCT/EP2012/068885 describes an analogous process using a bonding agent. Although the mechanical properties can be improved in this way, the level of properties of a shaped foam part produced from a block cannot be achieved.

DE 1817156 describes the production of a foamable composition consisting of, inter alia, a polymer of (meth)acrylic acid and methacrylonitrile containing formamide or alkylformamide as blowing agent as suspension polymer or as cast polymer to be granulated. Here, the only things considered to be important in carrying out the suspension polymerization are that large diameters of at least 0.6 mm are achieved and toxicologically problematical formamide is preferably used as blowing agent. Suspension polymers according to DE 1817156 having a diameter in the range from 0.6 to 1.0 mm are disadvantageous, however, in the filling of very complex moulds. It is shown that the polymerization would work independently of the dispersant system and the monomer composition. This is said to apply to both inorganic and organic dispersants, e.g. polyvinyl alcohol, polyvinylpyrrolidone or copolymers of acrylic acid. However, this is not so. Just the high proportion of organic acids such as (meth)acrylic acid is problematical from two points of view. Firstly, a large part of these monomers is present in the aqueous phase and therefore not available to the polymerization. Secondly, the acid-containing polymers formed lead to interfacial effects which make it impossible for the suspension polymerization to be carried out stably.

The same applies to the blowing agents. The blowing agents described in DE 1817156 all have a solubility in water which is so high that only part is incorporated into the suspension polymers and the wastewater is polluted. However, this leads to a number of disadvantages. Thus, the amount of blowing agent to be used is dependent on the way in which the process is carried out, in particular on the monomer composition, the ratio of monomer phase to aqueous phase and the temperature at which the suspension polymerization is carried out. This has a major effect on, in particular, the pore sizes later sought in the PMI foam. Thus, only densities above 120 kg/m³ can be demonstrated. Furthermore, the wastewater has to be purified in a complicated fashion after the polymerization. DE 1817156 therefore proposes that blowing agent-free polymer which is swollen by means of blowing agent in a further step be prepared. However, this represents an additional process step.

However, such suspension polymers would in principle have a great advantage over granules for the foaming operation. The smaller and more uniform particles would lead to a more uniform foam. Furthermore, an entire process step, for example granulation, is saved when using such a material.

However, the description of DE 1817156 dating from 1969 was not followed up further in the prior art even though PMI foams are important materials. The technical problems were, however, obviously too great. Only JP 2005-364784/EP 1964903A1 (Ejiri, Kureha Corp.) describes thermally foamable microspheres which have a core-shell structure and whose shell is formed by a copolymer which can form a polymethacrylimide structure and encapsulates a blowing agent in the interior of the shell. The copolymer which forms the shell is a copolymer of methacrylonitrile and methacrylic acid. The foamable core-shell microspheres described are obtained by suspension polymerization and are proposed for use as additives. However, this relates to a completely different field of technology and the teaching of JP2005-364784 is not able to provide suspension polymers for producing PMI foam workpieces.

### OBJECT

It was an object of the present invention to provide suspension polymers which are suitable for in-mould foaming of poly(meth)acrylimide (PMI) for producing PMI foam workpieces. In this case, suspension polymers having diameters of less than 0.6 mm should also be feasible.

In particular, it was an object of the present invention to produce polymer particles which are foamable and lead to foams having a high compressive strength and heat resistance. This should be achieved by selection of a process which circumvents the step of milling of polymer boards and provides foamable, particulate material in one step. In particular, the use of toxicologically problematical formamide derivatives should be dispensed with.

In particular, it was an object of the present invention to provide appropriate suspension polymers which after in-mould foaming lead to a defined and uniform pore size of the foam material.

It was a particular object of the present invention to be able to provide in-mould foams based on suspension polymers having a density of less than 100 kg/m³.

In addition, it was an object of the present invention to provide a process by means of which the production of lightweight crash elements composed of polymer foam composite mouldings, of mouldings and profile structures having a foam core and a covering layer or a plurality of covering layers, of sheet-like polymer foam composite mouldings, of integral components having force-introducing structures (inserts) or connecting or stiffening structures or the in-situ production of foam sheets is made possible.

Further objects which are not explicitly mentioned but underlie the present invention can be derived from the description, the examples or the claims.

### Achievement of the objects

The stated objects are achieved by means of a novel process for producing suspension polymers and by a subsequent process for foaming these suspension polymers, and by the suspension polymers produced by the process themselves.

To produce foamable, particulate material which can be processed in a mould to give compressively strong and heat-resistant foam bodies, a copolymerization of (meth)acrylonitrile, (meth)acrylic acid and thermally labile (meth)acrylic esters in a suspension polymerization, optionally in the presence of further organic compounds such as alcohols, is selected according to the invention. In addition, crosslinking components or further monomers which can be copolymerized with (meth)acrylonitrile can be incorporated into the polymer.

In particular, the objects are achieved by a novel process for producing suspension polymers for later foaming, in which an organic dispersant is used and the suspension polymerization is carried out at a temperature in the range from 60° C. to 100° C. The organic phase of the suspension polymerization contains from 30 to 70% by weight of (meth)acrylic acid, from 30 to 60% by weight of (meth)acrylonitrile, from 0.01 to 15% by weight of tert-butyl (meth)acrylate, isopropyl (meth)acrylate and/or cyclohexyl (meth)acrylate and from 0.01 to 2% by weight of initiators. Furthermore, the organic phase can contain up to 10% by weight of crosslinkers and up to 30% by weight of further alkyl (meth)acrylates and/or styrene.

Blowing agents employed here are copolymerizable (meth)acrylic esters, in particular tert-butyl (meth)acrylate, isopropyl (meth)acrylate and/or cyclohexyl (meth)acrylate which can eliminate gaseous products on heating. In addition, from 0.1 to 15% by weight, based on the organic phase, of further blowing agent which are not copolymerized and after the polymerization are present in atomic form in the suspension particles can be added. These preferably have a significantly better solubility in the organic phase than in the aqueous phase. These optional additional blowing agents are, in particular, alcohols, preferably C₃-C₇-alcohols and very particularly preferably n-propanol, isopropanol, n-butanol, tert-butanol, pentanols or hexanols. Formic acid or blowing agents having an amide structure, e.g. urea, monomethylurea or N,N′-dimethylurea, formamide or monomethylformamide, are less preferred. An additional effect as blowing agent can be displayed by small amounts of water which diffuse into the polymer particles during the suspension polymerization and remain there even after drying.

The use of the blowing agents indicated surprisingly makes it possible to produce suspension polymers which have a significantly smaller diameter compared to the prior art. The suspension polymers produced according to the invention preferably have a diameter in the range from 0.1 to 1.0 mm. Particularly preferably and in particular surprisingly compared to the prior art, theses suspension polymers have a diameter in the range from 0.2 to 0.8 mm, very particularly preferably from 0.4 to <0.6 mm, in particular <0.58 mm. The pores formed during foaming of this suspension polymer preferably have a diameter in the range from 10 to 500 μm, particularly preferably from 20 to 250 μm and very particularly preferably from 50 to 100 μm.

In the suspension polymerization according to the invention, the monomers and optionally further organic compounds and crosslinking components are polymerized in the presence of a dispersant and the initiator in water while stirring, giving polymer particles in which further organic compounds such as further blowing agents are optionally dissolved. Salts can be present in solution in the aqueous phase in order to reduce the solubility of the monomers and the optional further blowing agents in the aqueous phase. The dispersant used for the suspension polymerization is preferably a poly(meth)acrylic acid.

A particular advantage of the present invention is that the problems associated with the prior art, as discussed above, are overcome by the use according to the invention of thermally labile (meth)acrylic esters as blowing agents. It has surprisingly been found that the blowing agent is incorporated as monomer into the polymer in a suspension polymerization and precise setting of the blowing agent content is therefore possible via the monomer composition. Targeted setting of the pore size is therefore also possible for foamable polymers produced by means of suspension polymerization. Furthermore, no second process step for loading the polymer with blowing agent is necessary.

The size of the particles can be set within wide limits by means of the process of the invention. The size can, in particular, be set via selection of the dispersant used, the ratio of organic phase (in particular monomers) to aqueous phase, the reaction temperature or very particularly preferably the stirring speed. Variation of these process parameters is known in principle to those skilled in the art and can in each case be optimized for the specific monomer mixture by means of just a few experiments. The particle size itself has a direct influence on the distribution of the particles in a mould or the homogeneity of the foam during later foaming. Smaller particles can be distributed more uniformly, while larger particles lead to a mechanically somewhat more stable foam material. The selection of the particle size is thus dependent mainly on the application. The particles produced by means of the process of the invention preferably have a size in the range from 100 μm to 5 mm, preferably from 500 μm to 3 mm.

The process of the invention is particularly relevant for the production of poly(meth)acrylimide foams (PMI foams) which can be obtained by means of further process steps described below. The letters placed in parentheses denote an optional feature. Thus, for example, (meth)acrylic encompasses both acrylic and methacrylic and mixtures of the two compounds.

The production of rigid poly(meth)acrylimide foams is known per se and disclosed, for example, in DE 1 817 156 (U.S. Pat. No. 3,627,711), DE 27 26 259 (U.S. Pat. No. 4,139,685) or DE 199 17 987.

As indicated, the monomer mixtures used according to the invention can contain further monomers which can be copolymerized with (meth)acrylonitrile. These can be, for example, esters of acrylic or methacrylic acid, in particular with lower alcohols having C₁-C₄-radicals, styrene, maleic acid or its anhydride, itaconic acid or its anhydride, vinylpyrrolidone, vinyl chloride or vinylidene chloride, preferably alkyl (meth)acrylates and/or styrene. The proportion of the comonomers which cannot be cyclized or can be cyclized only with great difficulty should not exceed 30% by weight, preferably 20% by weight and particularly preferably 10% by weight, based on the weight of the monomers.

As further monomers, it is likewise advantageous to use, in a known manner, small amounts of crosslinkers such as allyl acrylate, allyl methacrylate, ethylene glycol diacrylate or dimethacrylate or polyvalent metal salts of acrylic or methacrylic acid, e.g. magnesium methacrylate. The proportions of these crosslinkers are, if used, frequently in the range from 0.005% by weight to 10% by weight, preferably from 0.1 to 5% by weight, based on the total amount of polymerizable monomers.

Furthermore, metal salt additives which frequently reduce smoke formation can be used. These include, inter alia, the acrylates or methacrylates of alkali metals or alkaline earth metals or of zinc, zirconium or lead. Preference is given to Na (meth)acrylate, K (meth)acrylate, Zn (meth)acrylate and Mg (meth)acrylate. Amounts of from 2 to 5% by weight of these monomers bring about a significant reduction in smoke density in the fire test in accordance with FAR 25.853a.

The suspension polymerization of the invention is carried out using organic dispersants. Preference is given to using poly(meth)acrylic acids, polyvinyl alcohols or poly(meth)acrylates having a high proportion of (meth)acrylic acid and/or other acids which can be copolymerized with (meth)acrylates. These polymeric acids can optionally be partially reacted with a base such as ammonia, sodium or potassium hydroxide or amines to form salts before use.

As polymerization initiators, use is made of the initiators customary per se for the polymerization of (meth)acrylates, for example azo compounds such as azodiisobutyronitrile and also peroxides such as dibenzoyl peroxide or dilauroyl peroxide or else other peroxide compounds such as t-butyl peroctanoate or perketals or else optionally redox initiators (cf., for example, H. Rauch-Puntigam, Th. Volker, Acryl- and Methacrylverbindungen, Springer, Heidelberg, 1967 or Kirk-Othmer, Encyclopedia of Chemical Technology, Vol. 1, pages 286 ff, John Wiley & Sons, New York, 1978). The polymerization initiators are preferably used in amounts of from 0.01 to 0.3% by weight, based on the starting materials. The initiators can also be used as a mixture of various initiators.

In addition to the initiators, chain transfer agents can be added in order to adjust the molecular weight. Examples of such chain transfer agents are n-butyl mercaptan, n-dodecyl mercaptan, 2-mercaptoethanol or 2-ethylhexyl thioglycolate. In general, these chain transfer agents are used in amounts of from 0.01 to 5% by weight, preferably from 0.1 to 2% by weight and particularly preferably in amounts of from 0.2 to 1% by weight, based on the monomer mixture.

Furthermore, the suspension polymers can contain conventional additives. These include, inter alia, antistatics, antioxidants, mould release agents, dyes, flame retardants, fillers, bonding agents, light stabilizers and organic phosphorus compounds such as phosphites or phosphonates, pigments and plasticizers. These additives preferably have a reduced solubility in water so that they are present in the polymer particles after the polymerization. As an alternative, these additives can also be added to the product at a later point in time. Such a point in time would be, for example, before drying or before introduction into a mould for foaming. Mould release agents can, for example, also be initially placed on the surface of the mould.

In a process step following the suspension polymerization according to the invention, the polymer is filtered off after the suspension polymerization and preferably dried at a temperature of not more than 100° C. This temperature restriction is preferred in order to prevent premature foaming during drying. The precise drying temperature depends on the blowing agents used.

The dried suspension polymer is then optionally heat treated at a temperature in the range from 110 to 130° C.

Finally, the suspension polymer produced is placed as a solid in a mould and foamed in this mould at a temperature in the range from 150 to 250° C., preferably from 220 to 250° C. This mould is, to ensure complete filling of the mould with foam, optionally turned, shaken or rotated during foaming. To discharge the blowing agent liberated, the mould is preferably provided with one or more pressure equilibrators, e.g. in the form of openings or valves.

The foaming time is usually in the range from 1 minute to 1.5 hours, preferably from 2 to 45 minutes and very particularly preferably from 3 to 30 minutes. The foaming time depends mainly on the blowing agent used, the foaming temperature and thus the desired density. A further influencing factor is the thickness of the component. After cooling, the polymer foam composite can be taken from the mould.

It has surprisingly been found that the process of foaming suspension polymers produced according to the invention and having the above-described composition in a mould leads to foam bodies which are both compressively strong and heat-resistant. The heat resistance is comparable with materials of the prior art which have been sawn or milled from foamed PMI boards, while the compressive strength is surprisingly only slightly poorer than that of corresponding bulk polymers which are very expensive to produce.

In a variant of the present invention, a covering layer is placed in the mould before introduction of the suspension polymers. A release agent can optionally be applied between mould and covering layer in order to aid removal of the polymer foam composite from the mould. This gives a shaped polymer foam composite. Appropriate process parameters and possible materials for the covering layer may be found in WO 2012/013393.

Apart from the process described, foam mouldings which can be obtained by means of the process of the invention or on the basis of the suspension polymers produced according to the invention are also provided by the present invention.

These likewise inventive foam mouldings are characterized in that they have a density in the range from 20 to 300 kg/m³, preferably from 30 to 200 kg/m³. These products can be distinguished in terms of their microstructure from foam mouldings of the prior art which have been produced either from cut foam boards or from larger granules. The foam materials of the invention display microscopically discernible, very uniform “interfaces” which reflect the original polymer particles. However, these “interfaces” surprisingly have only a small influence on the mechanical properties such as the compressive strength. Compared to foamed suspension polymers having exclusively noncopolymerizable blowing agents, in particular formamide, as have likewise been described in the prior art, the foam materials of the invention are distinguished by a more uniform and optionally smaller pore size and thus by distinctly better mechanical properties.

The foam mouldings of the invention have further surprising advantages:
A relatively homogeneous, virtually 100% closed-celled foam structure and a uniform cell size distribution without a significant preferential direction are present in the entire foam moulding.
Very good shaping is achieved by means of the foaming process according to the invention. Three-dimensional geometries having very small radii can be replicated, with very good replication of the three-dimensional geometry being obtained.
In the case of a composite moulding having covering layers, there is very good bonding to the covering layers. The force required to detach the covering layer (measurement method, standard: drum peeling test in accordance with DIN 53295), is, for example, greater than the peeling moments typical of the material for foam materials. For a commercial PMI foam)(ROHACELL®, these are in the range from 10 to 80 Nmm/mm. The polymer composite moulding has high flexural and torsional strengths, high creasing loads and very good denting behaviour.

The foam mouldings which can be obtained by the process of the invention or the polymer foam composite mouldings which can be obtained as a variant are, owing to their low weight and their excellent mechanical properties, suitable as, for example, components in space, air, sea and land vehicles, without this illustrative listing constituting any form of restriction.

### EXAMPLES

Examples 1 and 2 were carried out without crosslinker:

### Example 1

Aqueous phase: 500.0 g of water, 120.0 g of sodium sulphate and 7.4 g of Degapas 81055; Mw: 580 000 g/mol; 13.5% strength solution in water

Degapas 8105S is a polyacrylic acid from Osterreichische Chemiewerke

Organic phase: 114 g of methacrylic acid, 76 g of methacrylonitrile, 10 g of tert-butyl methacrylate, 0.9 g of AIBN, 0.9 g of dilauryl peroxide, 0.2 g of tert-butyl per-2-ethylhexanoate

The water was placed in a 1 l Schmizo reactor provided with porcelain blade stirrer, cooler and thermocouple and the sodium sulphate was dissolved therein at room temperature. The solution was heated to 75° C. and the monomer phase (solution of monomers and initiators) was added dropwise over a period of 35 minutes while stirring (170 rpm). The mixture was subsequently stirred at this temperature for another 1.5 hours. The dispersant was then added dropwise over a period of 2 minutes. An exothermic reaction could be discerned 4 hours after commencement of the reaction. The mixture was then stirred at 90° C. for another 1 hour and subsequently cooled to room temperature. 100 g of a 4% strength sodium percarbonate solution were added dropwise. The mixture was allowed to stand overnight at RT and the mother liquor was separated off the next day by means of a metal sieve (450 μm). The bead product was transferred to a porcelain suction filter and washed there with water (total of 2 l). The product was finally dried at 70° C. for a total of 20 hours in a vacuum drying oven.

### Example 2

Aqueous phase: 706.50 g of water, 176.47 g of sodium sulphate, 42.52 g of Degapas 8105S, 13.5% strength solution in water

Organic phase: 159.26 g of methacrylic acid, 120.14 g of methacrylonitrile, 14.70 g of tert-butyl methacrylate, 1.28 g of AIBN, 1.28 g of dilauryl peroxide, 0.29 g of tert-butyl per-2-ethylhexanoate

The water was placed in a 1 l Schmizo reactor provided with porcelain blade stirrer, cooler and thermocouple and the sodium sulphate was dissolved therein (internal temperature of about 75° C.). The ambient air in the reactor was displaced by means of dry ice. The stirring speed was 170 rpm. The organic phase was then added dropwise over a period of 30 minutes. After a reaction time of 2 hours at an internal temperature of about 77° C., the dispersant was added. A slight exothermic reaction was observed 4 hours after commencement of the reaction. The mixture was stirred at an internal temperature of 89.5° C. for 1 hour. The thermocouple was removed. After an after-reaction time of 1 hour, the mixture was cooled to RT and filtered through a 450 μm metal sieve. The coarse fraction was disposed of (coagulum, caked material), and the remainder was washed with 7 l of deionized water. The polymer was dried at 70° C. in a vacuum drying oven for a number of days.

Yield: >2 mm: 147.94 g (50.3% of the theoretical yield)

<2 mm: 122.18 g (41.5% of the theoretical yield)

### Example 3

### Monomer Mixture Containing Allyl Methacrylate as Crosslinker

Aqueous phase: 706.50 g of water, 176.47 g of sodium sulphate, 42.52 g of Degapas 8105S; 13.5% strength solution in water

Organic phase: 164.46 g of methacrylic acid, 124.23 g of methacrylonitrile, 5.74 g of tert-butyl methacrylate, 0.294 g of allyl methacrylate, 1.28 g of AIBN, 1.28 g of dilauryl peroxide, 0.29 g of tert-butyl per-2-ethylhexanoate

The water was placed in a 1 l Schmizo reactor provided with porcelain blade stirrer, cooler and thermocouple and the sodium sulphate was dissolved therein (internal temperature about 75° C.). The ambient air in the reactor was displaced by means of dry ice. The stirring speed was 170 rpm. The organic phase was then added dropwise over a period of 30 minutes. After a reaction time of 2 hours at an internal temperature of about 77° C., the dispersant was added. After a reaction time of 4 hours (exothermic reaction at 79.9° C., bath temperature 79.2° C.), the reaction temperature was increased to an internal temperature of 85° C. and the mixture was stirred at this temperature for 1 hour. The mixture was subsequently cooled to room temperature and filtered through a 450 μm metal sieve and washed with about 7 l of water. The residue was transferred to a porcelain suction filter provided with a round paper filter and washed again there with about 2 l of water. After the water had been removed by suction, the bead product was transferred to a crystallization basin and dried at 70° C. in a vacuum drying oven.

Yield: >2 mm: 11.37 g
<2 mm: 278.80 g

### Example 4

### Monomer Mixture Containing Allyl Methacrylate as Crosslinker

Aqueous phase: 706.50 g of water, 176.47 g of sodium sulphate, 42.52 g of Degapas 8105S; 13.5% strength solution in water

Organic phase: 163.94 g of methacrylic acid, 123.69 g of methacrylonitrile, 5.74 g of tert-butyl methacrylate, 0.735 g of allyl methacrylate, 1.28 g of AIBN, 1.28 g of dilauryl peroxide, 0.29 g of tert-butyl per-2-ethylhexanoate

Procedure analogous to Example 3

Yield: >2 mm: 35.85 g
<2 mm: 268.7 g

### Example 5

### Monomer Mixture Containing Allyl Methacrylate as Crosslinker

Aqueous phase: 706.50 g of water, 176.47 g of sodium sulphate, 42.52 g of Degapas 8105S; 13.5% strength solution in water

Organic phase: 163.61 g of methacrylic acid, 123.40 g of methacrylonitrile, 5.74 g of tert-butyl methacrylate, 1.47 g of allyl methacrylate, 1.28 g of AIBN, 1.28 g of dilauryl peroxide, 0.29 g of tert-butyl per-2-ethylhexanoate

Procedure analogous to Example 3

### Example 6

### Monomer Mixture Containing Ethylene Glycol Dimethacrylate as Crosslinker

Aqueous phase: 684.95 g of water, 175.38 g of sodium sulphate, 63.64 g of Degapas 8105S

Organic phase: 160.02 g of methacrylic acid, 120.86 g of methacrylonitrile, 14.80 g of tert-butyl methacrylate, 0.30 g of ethylene glycol dimethacrylate, 1.27 g of AIBN, 1.27 g of dilauryl peroxide, 0.30 g of tert-butyl per-2-ethylhexanoate

Procedure analogous to Example 3

The sodium sulphate and water were initially charged and dissolved with stirring and blanketing with nitrogen. Degapas 8105S was then added and the mixture was heated to 75° C. At 75° C., the monomer phase was added. The stirring speed was 300 rpm. During the next 4 hours and 46 minutes, the internal temperature rose to 76.7° C. After the temperature maximum, the internal temperature was increased to 85° C. and the mixture was allowed to react for 1 hour. The mixture was subsequently cooled to 20° C. and washed with 10 l of deionized water on a metal filter. The bead polymer was dried at 70° C. in a vacuum drying oven for about 3 days.

Batch size: 296 g; yield: 211.8 g (corresponds to 71.55% of theory)

### Example 7

### Monomer Mixture Containing Ethylene Glycol Dimethacrylate as Crosslinker

Aqueous phase: 684.95 g of water, 175.38 g of sodium sulphate, 63.64 g of Degapas 8105S; 13.5% strength solution in water

Organic phase: 152.62 g of methacrylic acid, 120.86 g of methacrylonitrile, 22.20 g of tert-butyl methacrylate, 0.30 g of ethylene glycol dimethacrylate, 1.27 g of AIBN, 1.27 g of dilauryl peroxide, 0.30 g of tert-butyl per-2-ethylhexanoate

Procedure analogous to Example 6. However, the product was dried in a fluidized-bed dryer.

### Example 8

### Organic phase containing ethylene glycol

dimethacrylate as crosslinker and tert-butanol as additional blowing agent

Aqueous phase: 684.95 g of water, 175.38 g of sodium sulphate, 63.64 g of Degapas 8105S; 13.5% strength solution in water

Organic phase: 152.62 g of methacrylic acid, 120.86 g of methacrylonitrile, 22.20 g of tert-butyl methacrylate, 0.30 g of ethylene glycol dimethacrylate, 1.27 g of AIBN, 1.27 g of dilauryl peroxide, 0.30 g of tert-butyl per-2-ethylhexanoate, 7.40 g of tert-butanol

Procedure analogous to Example 6. However, the product was dried in a fluidized-bed dryer.

### Example 9

### Organic Phase Containing Ethylene Glycol Dimethacrylate as Crosslinker and Tert-Butanol as Additional Blowing Agent

Aqueous phase: 684.95 g of water, 175.38 g of sodium sulphate, 63.64 g of Degapas 8105S; 13.5% strength solution in water

Organic phase: 152.62 g of methacrylic acid, 120.86 g of methacrylonitrile, 22.20 g of tert-butyl methacrylate, 0.30 g of ethylene glycol dimethacrylate, 1.27 g of AIBN, 1.27 g of dilauryl peroxide, 0.30 g of tert-butyl per-2-ethylhexanoate, 14.80 g of tert-butanol

Procedure analogous to Example 6. However, the product was dried in a fluidized-bed dryer.

### COMPARATIVE EXAMPLES

### Comparative Example 1

### Suspension Polymerization Using Inorganic (“Pickering”) Dispersant and without Crosslinker

Aqueous phase: 480 g of sodium sulphate solution, 35% strength in water

Dispersant: 13 g of aluminium hydroxide, high-purity

Organic phase: 45.9 g of methacrylic acid, 56.1 g of methacrylonitrile, 18.0 g of methyl methacrylate, 0.6 g of AIBN, 0.6 g of dilauryl peroxide, 0.30 g of tert-butyl per-2-ethylhexanoate, 14.80 g of tert-butanol

In a Schmizo reactor, 168 g of sodium sulphate were suspended at room temperature in 312 g of water and dissolved at 90° C. The solution was allowed to stand overnight at room temperature. The aluminium hydroxide was then added while stirring. The stirring speed was increased to 600 rpm. The organic phase was then added and the mixture was heated to an external temperature of 81° C. From an external temperature of 81° C. onwards, the time was counted as reaction time. After a reaction time of 3 hours, the mixture began to coagulate, indicated by the phases separating despite stirring. The monomer phase is not fully polymerized at this point in time. The reaction was stopped.

### Comparative Example 2

Apparatus: 1 l Schmizo reactor provided with stirring; cooler; nitrogen inlet and thermostat, and also thermocouple

Aqueous phase: 425 g of sodium sulphate solution, 35% strength in water

Dispersant: 9.74 g of aluminium sulphate hydrate=8.12% solids based on the organic phase

Precipitation: 39.84 g of sodium carbonate solution (10% strength)=3.32% solids based on the monomers, 9.74 g of sodium C₁₅-paraffinsulphonate solution (1% strength; corresponds to 1% based on the aluminium sulphate hydrate), 9.74 g of polyethylene glycol (molecular weight 5000-6000) (1% strength; corresponds to 1% based on aluminium sulphate hydrate)

pH after precipitation of the aluminium hydroxide: 5.00-5.50

Organic phase: 56.1 g of methacrylonitrile, 45.9 g of methacrylic acid, 18.00 g of methyl methacrylate, 0.60 g of dilauryl peroxide (corresponds to 0.5% based on the organic phase), 0.60 g of AIBN (corresponds to 0.5% based on the organic phase)

Conversion of the aluminium hydroxide into the sulphate after the end of the polymerization

Ratio of water:monomers=4:1

Procedure:

The aluminium sulphate was added to the 35% strength sodium sulphate solution prepared on the previous day (dissolved at 80° C.; then cooled to RT) and the mixture was stirred at 40° C. This resulted in dissolution of the sulphate. The hydroxide was then precipitated by means of sodium carbonate solution and the auxiliary dispersants were added. The initiated monomer solution was subsequently added and the emulsion was heated to an external temperature of 81° C. The mixture was stirred at 600 rpm for the entire time. After 3 hours, the mixture coagulated. After 5 hours, the reaction was stopped and the mixture was discarded.

### Comparative Example 3

### With Urea

Aqueous phase: 120.0 g of sodium sulphate, 480.4 g of water

Dispersant: 29.6 g of Degapas 8105S; 13.5% strength solution in water

Organic phase: 80.0 g of methacrylonitrile, 120.0 g of methacrylic acid, 20.0 g of urea, 0.90 g of dilauryl peroxide, 0.90 g of AIBN

Procedure:

The water together with the Degapas was placed in a 1 l Schmizo reactor provided with porcelain blade stirrer, cooler and thermocouple and the sodium sulphate was dissolved therein at room temperature. A short time later, a cohesive precipitate was formed, but this was redissolved as the mixture was heated to an internal temperature of 75° C. At a stirring speed of 170 rpm, the organic phase was added dropwise over a period of minutes at an internal temperature of 75° C. The reactor was made inert beforehand by means of dry ice. 9 minutes after commencement of the reaction, the mixture became turbid. An exothermic polymer reaction was observed 4 hours after commencement of the reaction. After 11 hours, the mixture was cooled to room temperature and allowed to stand overnight. On the next day, the mixture (consisting mainly of suspension polymers having a diameter of about 0.5 mm) was filtered with suction through a porcelain suction filter and washed 5 times with about 400 g each time of water. The bead product containing a little coagulum was dried under reduced pressure and at room temperature over silica gel in a desiccator for about 15 hours.

Yield: Coagulum: 21 g (9.5%); bead product sieved through 1.4 mm metal sieve: 189.3 g (86.0%)

### Comparative Example 4

Same amounts as in Comparative Example 3 but with addition of the dispersant after partial polymerization of the monomer phase.

The water was placed in a 1 l Schmizo reactor provided with porcelain blade stirrer, cooler and thermocouple and the sodium sulphate was dissolved therein at room temperature. In the production of the organic phase, the urea dissolved in the organic phase with gentle heating. At a stirring speed of 170 rpm, the organic phase was added dropwise at an internal temperature of 75° C. over a period of 35 minutes. The reactor had previously been made inert by means of dry ice. The mixture was then stirred at this temperature at 170 rpm for 1.5 hours. The mixture became turbid and small “droplets” could be seen. The dispersant was subsequently added dropwise over a period of 2 minutes. An exothermic reaction could be discerned 4 hours after commencement of the reaction. The mixture was then stirred at this temperature for another 4 hours. It was then cooled to room temperature. The mixture was allowed to stand for 4 days. 100 g of a 4% strength sodium percarbonate solution were subsequently added dropwise. The mixture foamed to some extent. The mixture was allowed to stand overnight at RT and the mother liquor was separated off via a metal sieve (450 μm) on the next day. The bead product was transferred to a porcelain suction filter and washed there with water (total of 2 l). The product was dried at 70° C. in a vacuum drying oven for a total of 20 hours.

Yield: 190.4 g (86.3% of theory)

Foaming of the Bead Polymers:

The foaming of the bead polymers in a mould was carried out in a heated press under the conditions listed in the table. The compressive strengths of the resulting foam bodies (determined at 3% deformation) are shown in the table.

| | Foaming | | Compressive |
|---|---|---|---|
| | parameters | | strength at 3% |
| Bead polymer | Temperature | Density | deformation |
| from example | (° C.)-Time (min) | (kg/m³) | (MPa) |
| Example 6 | 240-30 | 111 | 1.11 |
| Example 6 | 240-40 | 106 | 1.26 |
| Example 7 | 240-30 | 107 | 0.8 |
| Example 7 | 240-40 | 102 | 0.85 |
| Example 8 | 240-30 | 105 | 0.77 |
| Example 8 | 240-40 | 104 | 0.83 |
| Example 9 | 240-30 | 103 | 0.81 |
| Example 9 | 240-40 | 101 | 0.83 |
| Comparative | 240-30 | n.d. | n.d. |
| Example 3 | | | |
| Comparative | 240-40 | n.d. | n.d. |
| Example 4 | | | |

The foamed products of the examples produced according to the invention displayed a very uniform structure and high compressive strength, even at low densities.

Foaming of the suspension polymers from Comparative Examples 3 and 4, on the other hand, led to unstable, very heterogeneous products having a relatively high density. This means that only very little foaming has occurred. These materials had little compressive strength and were discarded.

1. A process for producing a suspension polymer for later foaming, the process comprising carrying out suspension polymerization of an organic phase in the presence of an organic dispersant, such that the suspension polymerization is carried out at a temperature in the range from 60° C. to 100° C., and the organic phase comprises:
from 30 to 70% by weight of (meth)acrylic acid;
from 30 to 60% by weight of (meth)acrylonitrile;
from 0 to 10% by weight of at least one crosslinker;
from 0.01 to 15% by weight of tert-butyl (meth)acrylate, isopropyl (meth)acrylate, cyclohexyl (meth)acrylate, or a mixture thereof, as a copolymerizable blowing agent;
from 0 to 30% by weight of at least one further alkyl (meth)acrylate, styrene, or a mixture thereof; and
from 0.01 to 2% by weight of at least one initiator,
to form a suspension polymer having a diameter ranging from 0.2 to below 0.6 mm.

2. The process of claim 1, wherein from 0.1 to 15% by weight of a C₃-C₇-alcohol, based on the organic phase, is additionally added as a second blowing agent to the organic phase.

3. The process of claim 1, wherein the organic dispersant is a poly(meth)acrylic acid.

4. The process of claim 1, wherein the suspension polymer is filtered off after the suspension polymerization and dried at a temperature of not more than 100° C.

5. The process of claim 4, wherein the dried suspension polymer is heat treated at a temperature in the range from 110 to 130° C.

6. (canceled)

7. A process for producing a foam moulding, the process comprising introducing a suspension polymer produced according to claim 1 into a mould and performing foaming in the mould at a temperature in the range from 150 to 250° C.

8. The process of claim 7, wherein the mould is turned, shaken or rotated during the foaming.

9. A foam moulding, obtained by the process of claim 7.

10. The foam moulding of claim 9, having a density in the range from 20 to 300 kg/m³.

11. The foam moulding of claim 9, having a density in the range from 30 to 200 kg/m³.

12. The foam moulding of claim 9, having a pore diameter in the range from 20 to 250 μm.

13. A component, comprising the foam moulding of claim 9, wherein the component is adapted to function in space, air, sea and land vehicles.
